(19) United States
(12) Patent Application Publication
(10) Pub. No.: US 2006/0151490 A1
(43) Pub. Date: Jul. 13, 2006

(54) Combination microwave oven pedestal and support cooking sheets for microwavable dough products

(76) Inventors: Angela N. Dodge, Schaumburg, IL (US); Suzy X. Zeng, Northfield, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/030,829

(22) Filed: Jan. 7, 2005

(51) Int. Cl. H05B 6/80

(52) U.S. Cl. 219/732

(57) ABSTRACT

A pedestal is provided for use in combination with a support such as a susceptor sheet which has a susceptor surface supporting a food product. The pedestal is positioned above a microwave oven floor. This combination functions to trap heated vapor within an open surface defined by the oven floor and pedestal. The support sheet and a dough-containing food product assembly has a storage mode which permits the food product to be stored within a refrigerated area of a convenience store. The planar portion of the pedestal and of the support sheet include openings in selected respective areas which generally align when in use.

### FIELD OF THE INVENTION

The present invention generally relates to improvements in connection with microwaving of dough-containing food products. The invention is particularly well suited for self-service convenience store cooking of dough products having a substantial crust volume which is to be subjected to microwave energy in order to cook or otherwise heat the dough and the rest of the food product so as to render it ready for serving and consumption.

### BACKGROUND OF THE INVENTION

Food products which require a minimum amount of consumer preparation and are quick to prepare are well suited for marketing in convenience store settings. Included in these are food products which traditionally are served hot or warm and include a heating step during the course of their preparation for consumption. Included in these types of food products are ones which incorporate a substantial volume of dough or batter which is formed into a product having a crusty surface. Such food products include those which are or have bread or crust components. Products of this general type include hot sandwiches, pocket-type food products, pitas, wraps, pizzas, calzones, pies and other dough-containing food products.

A substantial problem which must be addressed in preparing successful dough-containing food products such as those of these types arises when dough or batter products are subjected to microwave energy in order to cook and/or heat the food product. Problems in this general area have been recognized in many forums. Included is patent art such as Ottenberg U.S. Pat. No. 4,463,020, Meraj et al. U.S. Pat. No. 4,761,290, Cochran et al. U.S. Pat. No. 4,885,180, Huang et al. U.S. Pat. No. 5,035,904, King et al. U.S. Pat. No. 6,156,356, Paulucci U.S. Pat. No. 6,168,812 and McPherson et al. abandoned U.S. Published Patent Application No. 2002/0064586. Each of these is incorporated hereinto by reference. These references include proposals for formulating the dough or batter in a way that avoids or minimizes various negative impacts which are thought to be caused by the nature of microwave heating.

For centuries, the dough-making art has been based upon placing the dough to be baked or heated within an area providing primarily conduction heating. Generally, this approach cooks or heats through direct surface heating and drying effects of heated air surrounding the food being prepared. Contrary to these often called “conventional” approaches, applying microwave energy energizes polar and ionic molecules tending to result in heat generation. While the heating effects of such microwave energy depend on many factors, including shape, size, thickness and composition of the food product, there tends to be a heating from under the surface, or inside, of the food product out to its surface, while product surface temperatures remain relatively low due to evaporative cooling and low microwave cavity temperatures. In many situations, this heating is much more rapid along edge areas than it is in central areas of food products having somewhat uniform thickness, such as sheet pizzas. Unpalatable characteristics can develop, such as excess softness and/or sogginess, and/or toughness and a leathery texture when seeking to address sogginess. Sometimes, these negative texture attributes develop in some areas of the food product but not in others.

Contributing to reduced palatability of microwaved dough-containing food products is the difference in drying action when the same dough formulation is subjected to external heat as in a conventional oven when compared with heating achieved by the application of microwave energy to the food product. There is a tendency for less uniform liquid removal when a food product is subjected to microwave energy, especially when comparing same with conventional oven cooking or heating. Microwaved food products can exhibit undesirable soggy texture as well as the aforementioned leathery overcooked texture, typically in some areas of the food product but not in others. This is especially the case for such food products which are in a non-circular shape such as elongated, oval or polygon shaped products.

This background illustrates problems faced when attempting to formulate products having a substantial dough or batter component and that are intended to be cooked, baked or heated within a microwave oven. Some or all of the food product being heated can have a variety of palatability issues as discussed herein, including those such as sogginess which can be caused by having excess moisture within frozen food products, whether it is a dough component or another component such as a topping or filling. When all or some of the food product becomes overexposed to microwave energy, the aforementioned tough or leathery consistency can develop. These microwave issues can include having the crumb or the dough component take on a rubbery and/or gummy consistency. In general, a leathery crust becomes harder to chew and is not easily or pleasantly masticated.

The art, as generally represented by the patent art noted above, has made substantial strides in addressing these types of problems. This includes the dough formulation approaches discussed in each. Art such as Paulucci identified above propose susceptor sheet use. Other art in this general category includes several different variations on susceptor sheeting in an effort to solve this problem. Included are the following, each being incorporated by reference hereinto: Palowski U.S. Pat. No. 4,896,009, Swiontek U.S. Pat. No. 4,960,598, DeRienzo U.S. Pat. No. 5,223,685, Gics U.S. Pat. No. 5,565,228, Young U.S. Pat. No. 5,585,027, Sadek et al. U.S. Pat. No. 6,359,272, Cole et al. U.S. Pat. No. 6,414,290 and No. 6,765,182, Aronsson et al. U.S. Pat. No. 6,476,368 and Pedersen U.S. Pat. No. 6,627,862.

Art of this type generally recognizes that microwave cooking or heating is believed to be enhanced by providing a microwave susceptor material, such as aluminum, on a surface on which the food product rests. When microwaves strike the microwave susceptor material, higher temperature heating results. This heat generation is believed to be useful in ensuring thorough cooking via conduction of the underside of the food product in an effort to address issues such as soggy pizza crusts when microwave heated.

Designated patterns of holes and/or non-susceptor material on the susceptor surface have been proposed to enhance cooking uniformity. For example, U.S. Pat. No. 6,476,368 teaches providing a susceptor panel for heating garnished flat dough in microwave ovens. A plurality of apertures are provided in the susceptor panel for forming gas and microwave energy permeable areas which are taught to be positioned at specific locations on the susceptor panel to provide a designated pattern of openings in the susceptor surface which is designed to enhance microwave cooking of the food product. U.S. Pat. No. 6,414,290 proposes the use of an imperforate susceptor plate which has a designated pattern of microwave-transparent areas interspersed within the microwave susceptor surface. This is said to enhance crust browning.

U.S. Pat. No. 5,223,685 shows an elevated microwave cooking platform. The cooking surface of this platform has a series of larger openings intended to provide direct contact between food supported on the platform and air beneath the platform. Support legs elevate the platform and the food thereon so as to provide more room beneath the platform and the food supported on the platform. The support legs are widely spaced apart. Air circulating beneath the platform in between the widely spaced legs evaporates moisture from this air.

Approaches of the art thus far have not fully succeeded in providing microwave heated, cooked or baked dough-containing products that exhibit organoleptic properties and superior palatability for the same type of food product when it is heated, cooked or baked within a conventional oven which applies cooking and drying heat to the outside of the food product. The objective of parity between microwaved food products and the same type of product cooked by conventional oven approaches remains a challenge.

The challenge is all the greater when the microwave heating is to be carried out by patrons of convenience stores. In such circumstances, patrons carrying out a self-service cooking operation often are pressed for time, and may not be very familiar with the equipment and food products. Inconsistencies and calibration issues can arise because the equipment needs to be used by multiple patrons having different levels of dexterity and familiarity with the equipment. Furthermore, important economies of scale could be realized if multiple types of food products could be cooked with the same equipment, which could include food products of differing shapes, further complicating the efforts of minimizing sogginess and leathery consistencies of the differently shaped and constituted food products which are microwave heated.

Furthermore, susceptor devices add to the cost of the food products; yet, it is important from health and food safety points of view that they be disposable and do not need to be reused. This leads to a need to be able to use simple susceptors which require a minimum of manufacturing efforts and costs, while also requiring very little or no handling by the patrons of the convenience stores. Susceptors typically are packaged with the food product, usually with the susceptor surface being in contact with and/or directly opposite to a dough component of the food product.

Over the years, self-service units have been proposed which are intended to both store food products and provide the means for preparing the food products for consumption by the patrons of the self-service units. These include Greenburg U.S. Pat. No. 6,777,654, Conlan et al. U.S. Pat. No. 5,573,082, Ferrara et al. U.S. Defensive Publication No. T973,013, Bennett et al. U.S. Pat. No. 4,880,954, Anderson et al. U.S. Pat. No. 4,592,485, Pond U.S. Pat. No. 4,004,712 and Rubino U.S. Pat. No. 3,534,676. Some of these combine refrigerated storage locations with a microwave oven location within the same unit. Such approaches have not focused on combining these units with susceptor packaging or formulations specifically able to improve microwave cooking results.

It would be desirable to have an approach for improving a combination unit or kiosk which is a self-contained assembly of a refrigerated display unit for food products and of a microwave oven needed to properly heat, cook or bake any of the stored food products within the microwave oven.

It furthermore would be desirable to have the food products be provided as an assembly with their own inexpensive susceptors while realizing advanced cooking effects which minimize cooking unevenness of the type discussed herein. It is important that these results are achieved without considerable expense and with suitable versatility for the food products within the refrigerated display unit.

It has come to be appreciated that microwave oven cooking can be enhanced by elevating the food product above the floor of the oven. Approaches have been proposed by which susceptors themselves are modified from a typical flat panel to a tray having members for elevating the susceptor tray surface. In keeping with the invention as discussed herein, the elevation allows microwave radiation to bounce off the bottom walls of the microwave oven and directly reach the center of the bottom of the susceptor/product interface or of the support/product interface. A flow of heated air also develops, which is believed to increase the rate of cooking. However, achieving advances of these types leads to increased cost and complexity, both in manufacturing and in use.

According to the present invention, there has been a realization that kiosk units having refrigerated storage compartments and microwave ovens can be modified and improved to provide a combination of a packaged food product assembly having a flat and inexpensive disposable or recyclable susceptor sheet with a non-disposable pedestal which modifies the microwave oven floor in a manner that is advantageous to cooking evenness and speed and consistency. This general combination has been found to provide an important advance for convenience store usage.

The invention can be used for food items which are portable packaged food products including, for example, sandwiches, food wraps, pocket-type foods, enrobed foods, and other dough-containing food products, as well as meal dishes. These food products may include, for example, sandwiches (e.g., sandwich foods constructed with sliced bread, wraps, buns, or rolls, etc. and at least one edible filling such as meat, vegetable and/or dressing), gyros, burritos, egg rolls, pizzas, calzones, soy burgers, hot dogs, tacos, fajitas, nachos, meat pies, dumplings, pastries, pastry pies, meal dishes, and so forth.

### SUMMARY OF THE INVENTION

In accordance with the present invention, a pedestal for use within a microwave oven, especially one for use in a convenience store setting, is provided, such being for use in combination with a support member, such as a flat microwave susceptor sheet, that has openings through it and is sized and shaped to accommodate a dough-containing food product during a heating mode. The invention is especially useful when the food product is of a non-circular shape, although it also provides good results with circular food products as well.

The pedestal and the support or susceptor member each include openings therethrough which are provided to achieve flow of heat and steam through the pedestal and the support or susceptor member and onto the bottom of the food product. The pedestal includes an extending portion that cooperates with the rest of the pedestal and support or susceptor member to define a pedestal volume. During the cooking mode, this pedestal volume functions to hold a source of moist heated air directly beneath the food product being cooked or heated, thereby facilitating the advantageous microwave cooking effect of the invention. The elevation of the susceptor sheet or other support for the food product by the pedestal facilitates the heat distribution throughout the bottom of the product (included its center) by the reflection of microwave beams off the bottom walls of the microwave oven resulting in a resonance of energy at the surface of the susceptor or other support member.

In an aspect of the invention, the pedestal openings have a universal component in that they are suitable for a variety of dough-containing food products and support member or susceptor sheet hole patterns such that no or only a low percentage of support member or susceptor sheet hole area is blocked by the pedestal during food product heating, cooking or baking.

In a preferred aspect of the invention, one or more openings allow for material that is driven off from the food product during cooking to pass into the pedestal volume and be held there for a desired period of time and to allow cooking action though the openings in order to thereby impart uniform cooking of the food product during exposure to microwave energy.

In a further aspect of the invention which can, if desired, be used in combination with the other features disclosed herein, the support member or susceptor sheet can be made according to simple sheeting and hole cutting technology in order to provide a support or susceptor sheet which is very inexpensive and of virtually any desired perimeter shape.

It is a general aspect or object of the present invention to provide improved convenience store storage, display, sale and cooking of packaged microwaveable dough-containing food products which can have any of a variety of periphery shapes.

Another preferred aspect or object of the invention is to provide a microwave oven pedestal that accommodates a plurality of food product assemblies having a hole-containing microwave susceptor sheet whereby pedestal apertures provide open space beneath the susceptor sheet holes so as to avoid detrimental blockage of susceptor sheet holes, such combining to provide an underside volume of heated fluid onto the food product that enhances heating when the food product assembly having the susceptor sheet is positioned on the pedestal and subjected to microwave energy.

Another aspect or object of the invention, which can be combined with other features of the invention, is to provide a microwave dough-containing food product kit which includes the food product packaged on the support member or susceptor sheet, the pedestal within a microwave oven within a kiosk which also has a refrigerated storage and display compartment for the food product assemblies.

In an important aspect of this invention, the features of the invention enhance the value of convenience store food product marketing, including of thin crispy crust pizzas, sandwiches and the like which are designed to be cooked, baked or heated by microwave energy. A primary aspect of this enhancement is that the thus prepared food item has a uniformly heated crust throughout the food item. The prepared food item preferably has organoleptic and palatability characteristics which are not statistically distinguishable from like food products that are cooked, baked or heated by conventional heat-generating ovens such as those using convection principles.

These and other aspects, objects, features and advantages of the present invention, including the various features applied in various combinations, will be apparent from and clearly understood through a consideration of the following detailed description.

### BRIEF DESCRIPTION OF THE DRAWINGS

In the course of this description, reference will be made to the attached drawings, wherein:

FIG. 1 is a perspective view showing an arrangement which incorporates an embodiment of the invention;

FIG. 2 is an elevational view showing a preferred embodiment of the pedestal, the susceptor sheet and the food product in their combined cooking mode and as oriented within a microwave oven of the type included in FIG. 1;

FIG. 3 is a top plan view of the floor area of a microwave oven modified according to the invention;

FIG. 4. is a top plan view of a typical susceptor sheet according to the invention;

FIG. 5 is an enlarged cross-sectional view through a portion of FIG. 2, generally along the line 5-5;

FIG. 6 is a perspective view of a preferred pedestal of a type illustrated in FIG. 2 and FIG. 5;

FIG. 7 is a perspective view of another embodiment of a pedestal according to the invention;

FIG. 8 is a top plan view of a further embodiment of the pedestal according to the invention;

FIG. 9 is a top plan view of an additional embodiment of a pedestal according to the invention; and

FIG. 10 is a top plan view of another embodiment of a pedestal according to the invention.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

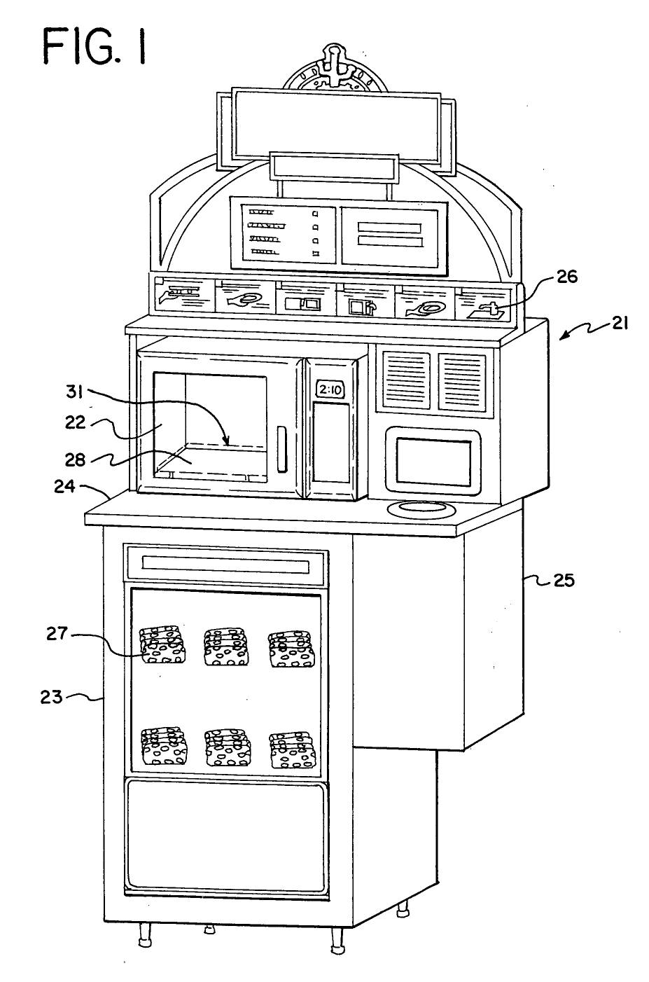

FIG. 1 illustrates an embodiment of a kiosk, generally designated as 21, which incorporates the invention. A microwave oven is generally designated as 22. A refrigerated storage case is generally designated as 23. Each of oven 22 and case 23 are components of the kiosk 21, which can include a service shelf 24, a disposal bin 25, and an instructions panel 26. A packaged dough-containing food product, generally designated as 27, is illustrated within the refrigerated storage case 23. The food products are refrigerated, and are typically frozen but also can be unfrozen as desired. The packaging can include product information to identify the product and contain other information as desired. Such packaging also provides barrier protection for the food product, as well as tamper evidence protection. In use, a patron of a convenience store or the like can select a food product 27 from the case 23, remove the packaging, discard the packaging in the bin 25, and place the unwrapped food product 27 into the microwave oven 22.

The microwave oven 22 is a typical oven having a floor area 28. In this illustrated embodiment, the floor is level and is essentially smooth. It will be appreciated that other microwave oven features can be included, such as a turntable (not shown) by which a food product being heated can be rotated for reasons known in the art. A pedestal, generally designated as 31, is shown in phantom in FIG. 1 within the oven 22.

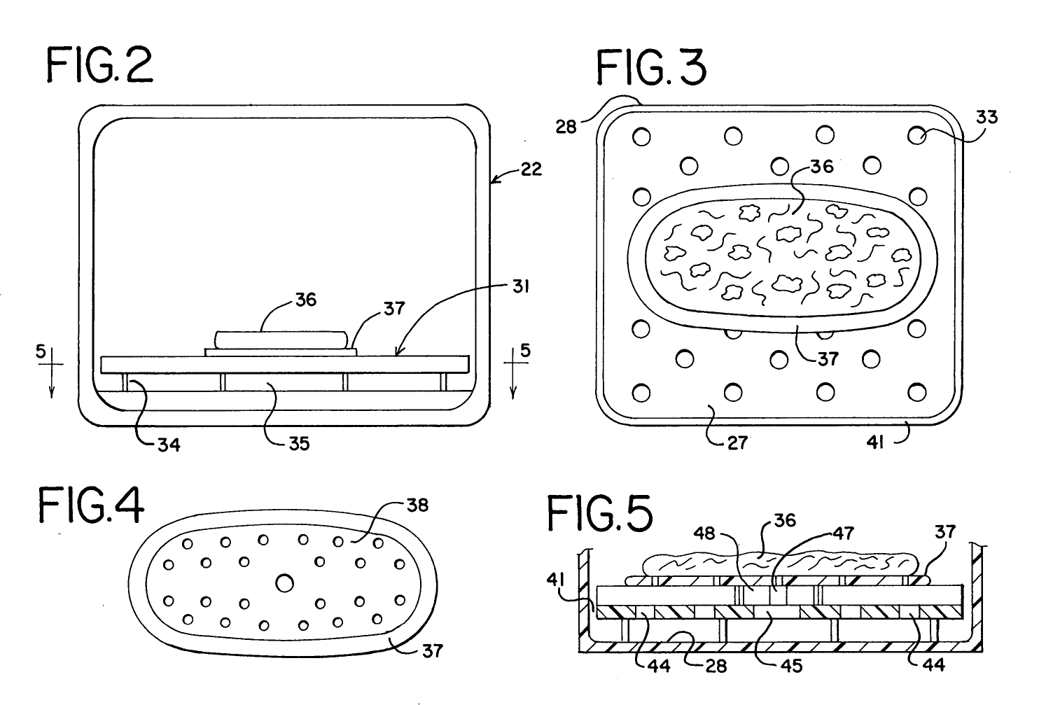

In this illustrated embodiment, shown in more detail in FIG. 2, the pedestal virtually fills the floor area 28 of the microwave oven. Such an approach permits full use of the floor area 28 and increases the versatility of the pedestal 31 in accommodating food products of different shapes and sizes. In this regard, it will be noted that apertures, such as those shown at 33 in FIG. 3, extend generally throughout the surface area of the pedestal 31. Pedestal 31 also includes an extending portion which can be in the form of members for raising the pedestal body above the microwave oven floor 28. In the illustrated embodiment, these are in the nature of legs 34, which can take the form of simple pegs, as discussed in greater detail elsewhere herein. The legs 34 perform an elevating function which, in cooperation with the close proximity of the edges of the pedestal 31 with the vertical walls of the microwave oven, create a pedestal volume at 35. The beneficial aspects of such volume are discussed elsewhere herein.

Turning now to the food product assembly 27, this includes food product itself 36 and a support member. For purposes of description of the invention, this support member is discussed as being a susceptor sheet 37 which has a susceptor surface in contact with the food product, which is suitable for products to have a browned surface when cooked. When the support member is a microwave susceptor sheet 37, same includes a susceptor surface 38, as seen for example in FIG. 4.

The support member, such as the illustrated susceptor surface 38, has a plurality of holes 39 which extend through the sheet 37 itself. This illustrated susceptor surface 38 is on a generally planar portion of the susceptor sheet 37. It will be appreciated that the terms generally planar or planar can encompass surfaces having depressions, raised portions, texture, holes, perforations and the like, and is not intended to mean planar in a strict geometric sense. As is generally known, susceptor material contributes to browning of dough products such as pizza crusts. The susceptor material causes localized heating which develops temperatures that are more elevated than other non-susceptor areas. Such elevated temperatures promote Maillard reactions in the crust or other dough material where contact occurs between same and the susceptor material. This effect is less likely to be observed in areas without direct contact of this type, such as at openings where no susceptor material is present.

As previously noted, the pedestal 31, together with an extending portion such as the legs 34, define the volume 35 of the microwave pedestal 31. The elevation level of the support or susceptor member affects the microwave beam direction/re-distribution to reach the center of the bottom of the product by reflecting microwave beams off the side and bottom walls of the microwave oven. Microwave beams reflect off the walls of the microwave oven in a manner symmetric to their incidental angle. The reflection of the microwave beams results in cancellation and resonance phenomena in the space between the walls and the product. This pedestal volume also functions to enhance cooking and/or moisture retention, and often also to improve cooking uniformity, in cooperation with close spacing 41 between the pedestal and the oven walls as well as the openings through the support or susceptor sheet 37.

For most food products and support members or susceptor sheets or trays, the height measurement of the pedestal legs will be between about 0.1 inch and about 1.2 inch (about 0.25 cm and about 3 cm), preferably between about 0.125 inch and about 0.75 inch (between about 0.3 cm and about 1.9 cm). This provides spacing of this height between the bottom of the pedestal and the floor 28 of the microwave oven 27. A typical pedestal will have legs having a preferred height of about 0.25 inch (about 0.64 cm). A typical perimeter of a pedestal has a length of about 13.25 inches and a depth of about 15.5 inches (between about 34 cm and about 40 cm).

The extent and confining nature of the pedestal volume 35 play an important role in enhanced microwave heating performance achieved by the invention. Important to such performance is the combination of the size of this confined pedestal volume with its location under the microwave cooking surface such as that provided by the susceptor surface 38 of the microwave susceptor sheet. The importance of this combination is discussed in greater detail elsewhere herein.

With further reference to the pedestal volume and its function, a plurality of openings are included which provide locations of access between the support or susceptor surface 38 and the pedestal volume 35. The openings thus provide means for passing byproduct material and energy from the baking, cooking or heating of the dough-containing food product through the support or susceptor sheet and pedestal and into the location of the pedestal volume 35. Materials which are especially important in this regard are vapors which are given off by the food product during heating. For example, the openings facilitate dissipation of water vapor generated during baking, heating or cooking, especially of a frozen food product, which could otherwise lead to development of a soggy bottom surface of the food product.

Furthermore, materials, especially steam, driven off from the food product pass through the openings and help to provide a medium for enhanced heating or cooking action within the confined volume below the pedestal and support or susceptor surface. In essence, vapors or other food byproduct materials provide a heated medium within the pedestal volume. That heated medium provides a warm air or a convection heating which approximates the type of heating action provided by a non-microwave, conventional oven. It also provides a “steam effect” that further heats the bottom of the food product The elevation of the food and its support or susceptor ensures the direct heating of the whole bottom surface of the support or susceptor via bouncing of the microwave energy off the walls of the microwave oven. When the bottom is a crust, this gives it a crispy bottom texture and an even, brown color. This steam is preferably controlled to keep the proper amount of moisture in the food product in order to prevent the crust from becoming too hot and dehydrated, resulting in an overcooked crust that can become too hard, tough and chewy.

This steam effect assists in heating, baking, or cooking the food product while providing an additional, moist heat source from below the food product, thereby cooperating with the microwave energy heating in order to provide enhanced heating action according to the invention, which results in food products having palatability and organoleptic properties which mimic those of like food products which are cooked, baked or heated within a conventional, non-microwave oven.

With further reference to the openings 39 in the susceptor sheet 37, these are sized, shaped and positioned to enhance cooking effects of the heated medium from the pedestal volume 35. Such can include a variety of opening sizes and shapes in a designated pattern. This is referred to as an enhancement pattern or an enhancement hole pattern. One of the aspects of the present invention is that the pedestal 31 does not interfere to any substantial extent with the advantageous cooking results provided by the enhancement hole pattern of the susceptor sheet 37. Typically, the pedestal will have an open area of at least about 15 percent of the pedestal generally planar portion, often at least about 25 percent, and for some embodiments at least about 40 percent or at least about 50 percent of the pedestal generally planar portion.

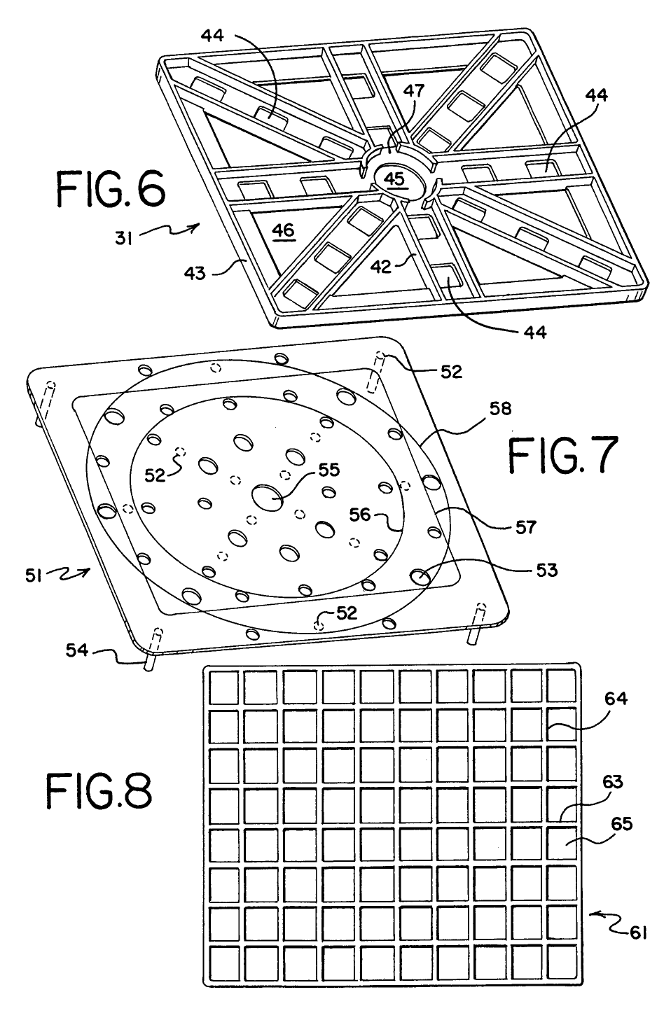

This lack of substantial interference is illustrated in FIG. 5 which includes a cross-section through the preferred pedestal 31 that is shown in FIG. 6. It will be noted that this pedestal has substantial open volume while still providing adequate support functionality to maintain food product assembly 27 above the pedestal volume 35. In this particular embodiment, support spans 42 extend from one part of a peripheral frame 43 of the pedestal to an opposing location on this peripheral frame 43. Each support span is perforate. In the illustrated arrangement, the perforate property is provided by a plurality of openings 44. In the illustrated embodiment, the openings 44 are generally square, but any other shape also provides good functionality, such as circular, triangular, or other shapes as desired. Also included is a central aperture 45. Open areas 46 (FIG. 6) of the pedestal remain between the support spans 42.

It will be appreciated that, with an arrangement such as shown in FIGS. 5 and 6, substantial open pedestal space is provided. This openness minimizes the blocking effect of the pedestal itself. Thus, the food product assembly 27, including the support member or susceptor sheet 37, combine to define the actual pedestal volume that is provided for the particular food product assembly being heated or cooked.

With further reference to the pedestal 31 illustrated in FIG. 5 and FIG. 6, enhanced heated fluid flow can be attained by providing gaps within one or more upstanding walls of the pedestal 31. For example, a circular upstanding wall 48 surrounds the central aperture 45, and gaps 47 are shown through this particular wall 48. The gaps provide a flow path for heated air generally along the surface of pedestal 31 and under the outside surface of the susceptor sheet 37 of the food product assembly 27 when on top of the pedestal.

As can be seen in FIG. 5, in multiple instances, the holes 39 of the support member or susceptor sheet align with one or more of openings 44, central aperture 45, or open areas 46 of the pedestal 31. It also will be noted that portions of the food product 36 itself are positioned above these aligned openings so as to expose the food product to the heated volume as previously discussed.

Another embodiment of the pedestal is shown in FIG. 7. The pedestal 51 of FIG. 7 is generally square in configuration and is sized so as to closely fit within a microwave oven, such as is the case for pedestal 31. Receptor openings 52 are provided for legs 54. These legs are in the nature of pegs that are forcefit, threaded or glued into the openings 52. Multiple openings 53 are provided in order to achieve the type of alignment effect which has been discussed in connection with the preferred pedestal 31. In addition, a central aperture 55 is provided. It will be appreciated that, with many support members or susceptor sheets of the food product assembly 27, the pedestal openings 53 provide substantial alignment between openings 39 in the susceptor sheet and these openings 53 and 55 of the pedestal 51.

FIG. 7 illustrates an option for facilitating alignment between pedestal holes, such as openings 53 and the aperture 55 on the one hand and holes 39 in the enhancement pattern of the member or sheet 37 on the other hand. A plurality of product outlines are shown. Included is an oval outline 56. With this arrangement, the holes 39 of the support or sheet 37 are positioned in a pattern that corresponds to the hole pattern which is within the oval outline 56. A square outline 57 also is provided on the pedestal 51. The enhancement hole pattern of a square support sheet, for example, can be provided to correspond with holes within the perimeter of the square outline 57. Also illustrated is a circular outline 58 which delineates a particular hole pattern that can find correspondence within the hole pattern of a circular susceptor tray 37, for example. It will be appreciated that such product outlines can be included with any of the pedestals discussed herein.

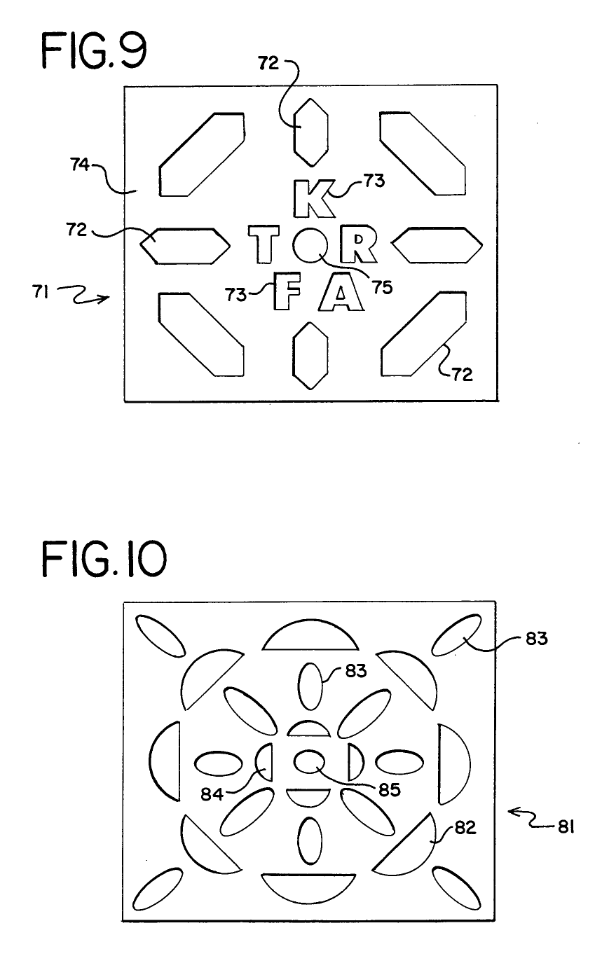

FIG. 8 shows a further embodiment, including pedestal 61. In this embodiment, the openness is even greater than those of the other embodiments. The overall structure of this can be considered as a coarse screen pattern. This pedestal has a frame 62 as well as a plurality of longitudinal cross members 63 and a plurality of lateral cross members 64. These components define a plurality of open spaces 65. It will be appreciated that open spaces 65 constitute a large majority of the area defined by the frame 62. In addition, the pattern of this embodiment is symmetrical in its spacing and positioning of the open spaces 65, meaning that the holes 39 of the support member or sheet 37 can be readily aligned with such open spaces 65.

FIG. 9 shows a further embodiment. A pedestal 71 is shown. This has a perimeter that closely follows the inside perimeter of the microwave oven within which it is intended for use. A plurality of outward openings 72 are shown. The particular illustrated outward openings 72 are polygonal in shape, more particularly in an elongated six-sided shape. The elongated aspect is believed to facilitate the hole alignment attribute of the invention previously discussed herein. A central aperture 75 also is shown. A plurality of inward openings 73 are positioned between the outward openings 72 and the central aperture 75. The particular illustrated inward openings have a novelty and/or brand identity function insofar as these particular illustrated openings are in the form of recognizable alphabet letters. The particular letters illustrated spell the company identifier “KRAFT.” It will be noted that these openings and apertures provide open spacing through the pedestal surface and that such spacing is distributed throughout much of the available pedestal surface. In this embodiment, imperforate areas 74 provide adequate support for the food product assembly 27.

FIG. 10 illustrates a further pedestal 81. Multiple openings are provided through the pedestal surface which are in addition to the central aperture 85. The illustrated openings each have a curved sidewall. These include semi-circular types of openings 82, oval or ellipse openings 83 and arc openings 84. A generally symmetrical pattern is provided by openings 82, 83 and 84, which facilitates hole aligning placement of the food product assembly 27 and its enhancement hole pattern.

With further reference to the openings in the pedestal and/or in the support member or susceptor sheet, they can be straight, curved, slit-like, of a point-like configuration, be intersecting lines, or be openings of regular symmetrical shapes such as circles, squares or triangles. FIG. 9 illustrates that the openings can take the form of indicia of recognizable shapes such as letters of the alphabet, arcs 54, numbers and the like. The length, number, size and placement of the openings can vary depending on the size and shape of the food product.

Referring further to the openings provided in the pedestal, it is generally preferred that such openings be approximately symmetrically spaced along the pedestal. Preferably, adequate spacing is provided between adjacent openings to minimize weakening of the structural integrity of the pedestal. It has been found that by thus maintaining the strength and structural integrity of the pedestal, the pedestal surface is better able to provide and maintain a flat, planar surface for the susceptor sheet of the food product during production, storage and use. Such a flat, planar pedestal surface enhances cooking consistency by providing a surface that provides predictable interaction with the susceptor sheet and thus of the susceptor sheet with the dough of the product resting on it during microwave cooking.

It will be appreciated that the openings in the illustrated susceptor sheet represent the absence of susceptor material and the attendant reduction in heating which is attributable to microwave energy impingement upon the susceptor material. Generally speaking, where susceptor material is not present, the browning effects of the microwave energy are reduced in intensity. Relatively small sized and relatively evenly spaced openings which define the enhancement pattern help to ensure that there will be minimal development of noticeable light-colored areas on the bottom of the food product crust.

The correct elevation and the surface area defined by the perimeter of the pedestal make up the volume underneath the pedestal planar surface, which is coupled with the correct number and size of openings and/or apertures to allow the needed amount of moisture or steam to leave the dough yet not dry it out. It is important that the legs provide the function of elevating the pedestal and thus the susceptor surface above the floor of the microwave oven, combined with the function of the pedestal and support member or susceptor sheet in providing a substantial barrier to the escape of vapor and other byproduct material from heating the food product so that same will remain within the pedestal volume 35 for a length of time that significantly enhances the heating, cooking or baking function as described herein.

It will be appreciated that the size of the volume delineated by the pedestal when in use within a microwave oven will depend upon the dimensions of the pedestal. To a large degree, this volume depends upon the area of the periphery or footprint of the generally planar portion of the pedestal and the height of the planar portion from the floor of the microwave oven. The larger the product of this area dimension times this height dimension, the greater will be pedestal volume. The pedestal volume substantially defines the boundaries for the vapor that can be accommodated by the pedestal. The extent that the maximum calculated volume truly constrains the vapor will depend in part upon the opening and porosity features of the susceptor tray, as discussed elsewhere herein.

Pedestals according to the invention are to be made of material that is suitable for use within a microwave oven for lengthy time periods and through numerous heatings. These include ceramics, heat resistant polymers, for example polycarbonates, and other materials known or to be known for use within microwave ovens. Typically, the materials will be rigid and very durable. In the preferred arrangement, the pedestals closely fit the footprint of the microwave oven. Side spacing 41 is preferably adequate to permit one to grasp the pedestal and lift it out of the microwave oven, such as for cleaning, exchanging pedestals, and other functions. While it is generally preferred that a single pedestal be suitable for use with any possible food product assemblies, it is also possible that different pedestals or platforms can be provided for different products or types of products, such as to provide a different level of air circulation or pedestal volume.

Typically, the support members or susceptor sheets are disposable and/or recyclable and will be made of paperboard material, with the exception of the susceptor surface itself, when included. It is possible that less or more of the outside surface of the paperboard than the generally planar area can be coated with susceptor material. For example, it can be possible to manufacture a tray made of paperboard which is substantially completely covered with susceptor material, on one or both sides or surfaces thereof.

Usually, the shape of the support or susceptor surface, and also often the shape of the support member or susceptor sheet, should correspond to, or be complementary with, the shape of the food product being heated, cooked or baked. Exemplary shapes include circles, ovals, ellipses, oblong shapes, squares, rectangles, triangles, octagons, and other polygons.

An illustration of a microwaveable dough-containing food product is a thin crust pizza. Included is a dough layer or crust having a central area which extends throughout the crust except for at its periphery. Typically, one or more toppings fill this area. In an illustrated embodiment, a sauce topping has a second topping, such as of cheese material, on its surface. Other toppings can be added as desired. Any of these toppings can be varied as desired in order to suit particular tastes. Subjecting the food product to microwave energy while supported according to the invention results in heating, cooking or baking the crust, whether frozen, refrigerated or at room temperature and whether unbaked, partially baked or substantially fully baked. Simultaneously, the other components of the food products such as a topping or toppings are heated until the desired degree of cook is achieved.

Another product of the type that is suitable for this invention is a sandwich or pizza having a general oblong configuration, such as is provided by a piece of French bread sliced laterally. A typical product of this type could fit on an oblong or oval-type susceptor sheet which is about 3.5 inches by about 7 inches (about 9 cm by about 18 cm). A typical susceptor sheet enhancement hole pattern for such a product would include a central hole and twelve perimeter holes. Another approach is to have a central hole surrounded by as many as 24 holes which are spaced no closer than about 0.625 inch (about 1.6 cm) from the susceptor sidewall.

It will be understood that the embodiments of the present invention which have been described are illustrative of some of the applications of the principles of the present invention. Numerous modifications may be made by those skilled in the art without departing from the true spirit and scope of the invention. Various features which are described herein can be used in any combination and are not limited to precise combinations which are specifically outlined herein.

1. A combination for cooking food products at a public facility, comprising:
a multiple-use pedestal, said pedestal having a generally planar portion with a perimeter, an inwardly facing face and an outwardly facing face;
a support member having an upper face with a food-supporting surface and a lower face;
a dough-containing food product having a perimeter and being adapted to rest upon said upper face of the support member during a cooking mode which includes heating of the dough-containing food product by a microwave oven, said lower face of the support member being adapted to rest on said outwardly facing face of the pedestal;
an extending portion of said pedestal which projects generally away from said inwardly facing face thereof and in a direction generally opposite to the direction of the food-supporting surface;
said extending portion and said inwardly facing face of the pedestal generally define a pedestal volume;
holes through said support member, said holes being according to a predetermined enhancement pattern for achieving desired microwave cooking;
apertures through said generally planar portion of the pedestal, a majority of said holes of the support member enhancement pattern being in gas passing alignment with at least some of said apertures of the pedestal; and
said holes and apertures are adapted to facilitate passage of heat-generating byproduct including vapor from the dough-containing food product.

2. The combination in accordance with claim 1, wherein said support member is a susceptor sheet which is a planar member that is inexpensive and disposable.

3. The combination in accordance with claim 1, wherein said pedestal is sized and shaped to be closely accommodated by a floor area of a microwave oven by close spacing.

4. The combination in accordance with claim 1, wherein said extending portion of the pedestal comprises a plurality of legs extending downwardly from said generally planar portion thereof.

5. The combination in accordance with claim 1, wherein said extending portion of the pedestal extends downwardly beyond its said inwardly facing face for between about 0.25 cm and about 3 cm.

6. The combination in accordance with claim 1, wherein said perimeter of the food product is generally oval in shape, and wherein said support member is a susceptor sheet having a susceptor surface that is generally oval in shape.

7. The combination in accordance with claim 1, wherein said apertures of the pedestal comprise at least about 15 percent of the generally planar portion thereof.

8. The combination in accordance with claim 1, wherein said apertures of the pedestal comprise between about 25 and 75 percent of the generally planar portion thereof.

9. The combination in accordance with claim 1, wherein said apertures of the pedestal comprise at least about 50 percent of the generally planar portion thereof.

10. The combination in accordance with claim 1, wherein said pedestal includes a peripheral frame, a plurality of support spans between said frame and open areas between said support spans, and further including upstanding walls.

11. The combination in accordance with claim 10, wherein at least one of said upstanding walls includes a gap in said wall.

12. The combination in accordance with claim 1, further including one or more pedestal product outline indicia means for indicating placement of the susceptor sheet on the pedestal.

13. The combination in accordance with claim 12, wherein said product outline indicia means circumscribe a plurality of pedestal apertures which generally correspond with said holes enhancement pattern of the susceptor sheet.

14. The combination in accordance with claim 1, wherein said pedestal generally planar portion comprises a coarse screen pattern having a plurality of longitudinal cross members which intersect with a plurality of lateral cross members.

15. The combination in accordance with claim 1, wherein said pedestal generally planar portion comprises a plurality of elongated outward openings, a central aperture and a plurality of inward openings therebetween.

16. The combination in accordance with claim 1, wherein said pedestal apertures are selected from alphabet letters, numerical indicia, openings having curved sidewall portions, slits, points, intersecting lines and polygons.

17. The combination in accordance with claim 1, wherein said pedestal is durable under multiple use activity within a microwave oven and is substantially rigid.

18. A combination for cooking food products at a public facility, comprising:
a multiple-use substantially rigid pedestal, said pedestal having a generally planar portion with a perimeter, an inwardly facing face and an outwardly facing face, said pedestal being sized and shaped to be closely accommodated by a floor area of a microwave oven;
a susceptor sheet having an upper face and a lower face, said upper face of the susceptor sheet having a susceptor surface thereon for enhancing microwave cooking of food product in contact with same, said susceptor sheet being planar, inexpensive and disposable;
a dough-containing food product having a perimeter and being adapted to rest upon said susceptor surface during a cooking mode which includes heating of the dough-containing food product by a microwave oven, said lower face of the susceptor sheet being adapted to rest on said outwardly facing face of the pedestal;
an extending portion of said pedestal which projects generally away from said inwardly facing face thereof and in a direction generally opposite to the direction of the susceptor surface;
said extending portion and said inwardly facing face of the pedestal generally define a pedestal volume;
holes through said susceptor surface of the susceptor sheet, said holes being according to a predetermined enhancement pattern for achieving desired microwave cooking; and
apertures through said generally planar portion of the pedestal, a majority of said holes of the susceptor surface enhancement pattern being in gas passing alignment with at least some of said apertures of the pedestal, said apertures comprising at least about 15 percent of the generally planar portion thereof.

19. A combination for cooking food products within a microwave oven, comprising:
a multiple-use and durable pedestal, said pedestal having a generally planar portion with a perimeter, an inwardly facing face and an outwardly facing face, said pedestal being sized and shaped to be closely accommodated by a floor and wall of a microwave oven;
a susceptor sheet having an upper face and a lower face, said upper face of the susceptor sheet having a susceptor surface thereon for enhancing microwave cooking of food product in contact with same, said susceptor sheet being inexpensive and disposable or recyclable;
a dough-containing food product having a perimeter and being adapted to rest upon said susceptor surface during a cooking mode which includes heating of the dough-containing food product by a microwave oven, said lower face of the susceptor sheet being adapted to rest on said outwardly facing face of the pedestal;
an extending portion of said pedestal which projects generally away from said inwardly facing face thereof and in a direction generally opposite to the direction of the susceptor surface;
said extending portion and said inwardly facing face of the pedestal generally define a pedestal volume;
holes through said susceptor surface of the susceptor sheet, said holes being according to a predetermined enhancement pattern for achieving desired microwave cooking; and
apertures through said generally planar portion of the pedestal, a majority of said holes of the susceptor surface enhancement pattern being in gas passing alignment with at least some of said apertures of the pedestal.

20. The combination in accordance with claim 19, wherein said apertures of the pedestal comprise at least about 15 percent of the generally planar portion thereof.
